(19) United States
(12) Patent Application Publication
(10) Pub. No.: US 2003/0202442 A1
(43) Pub. Date: Oct. 30, 2003

(54) Optical disk recording/reproduction apparatus and write power control method

(75) Inventors: Hiroshi Kubota, Fussa-shi (JP); Shigeo Tsuchiya, Yokohama-shi (JP)

Correspondence Address: PILLSBURY WINTHROP, LLP, P.O. BOX 10500, MCLEAN, VA, 22102, US

(73) Assignee: KABUSHIKI KAISHA TOSHIBA, Tokyo (JP)

(21) Appl. No.: 10/424,781

(22) Filed: Apr. 29, 2003

(30) Foreign Application Priority Data
Apr. 30, 2002 (JP) 2002-128825

(51) Int. Cl. G11B 7/125

(52) U.S. Cl. 369/47.53; 369/53.27

(57) ABSTRACT

The amount of reflected light from an optical disk being irradiated with laser light emitted from a laser diode is measured while the emission power of the laser diode is changed, thereby obtaining a reflected light amount characteristic of reflected light amount versus emission power. The reflected light amount characteristic is normalized using a component proportional to the emission power of the laser diode. The optimum write power is determined based on the normalized reflected light amount characteristic. As a result, in an optical disk recording and reproducing apparatus, the laser write power can be adjusted in a short time with certainty.

### CROSS-REFERENCE TO RELATED APPLICATIONS

This application is based upon and claims the benefit of priority from the prior Japanese Patent Application No. 2002-128825, filed on Apr. 30, 2002, the entire contents of which are incorporated herein by reference.

### BACKGROUND OF THE INVENTION

1. Field of the Invention

The present invention relates to an optical disk recording/reproducing apparatus which records or reproduces information on or from an optical disk using a laser beam and more specifically to a laser power control technique at information record time.

2. Description of the Related Art

In reproducing information recorded on an optical disk, use is made of a light beam of relatively low power. The light beam is directed to the spinning optical disk and marks or pits formed on the disk are detected based on changes in the intensity of reflected light from the disk, whereby the recorded information is reproduced.

To record information on an optical disk, marks are formed by light beam irradiations on the disk, along a spiral track. These marks are areas that underwent a change in optical property, such as reflectance, through write laser beam irradiations. The marks are recorded by irradiating the disk with a laser beam of a power greater than that used for reproduction. Thus, power needed by the laser for recording of marks is referred to as the write power.

For recordable optical disks, such as DVD-RAM, DVD-R, CD-RW, CD-R, etc., at write power control time, the amount of reflected light is measured while the laser beam power is changed (i.e., at various laser power levels). The write power is adjusted so that the amount of reflected light reaches a certain value.

At the time of controlling the write power, in a range of emission power in which it is too low to form marks on the disk, the amount of reflected light increases as the emission power increases. However, when the emission power is increased to a range in which marks can be formed, the amount of reflected light will generally decrease since part of the emission power is absorbed by the disk. The write power is adjusted within this range. In this range, however, depending on the optical pickup, the amount of reflected light may only change slightly, or may increase (the polarity of change of the amount of reflected light may be reversed) with increasing emission power.

As a result, in controlling the write power so that a given amount of reflected light is achieved, the direction to change the write power (whether it is to be increased or decreased) cannot be determined, and hence controlling becomes difficult.

### BRIEF SUMMARY OF THE INVENTION

According to an aspect of the present invention, there is provided an optical disk recording and reproducing apparatus comprising: a laser light emitting section which directs laser light onto an optical disk; a judgment section which measures the amount of reflected light from the optical disk while changing the emission power of the laser emitting section and judges a reflected light amount characteristic of reflected light amount versus emission power; a normalization section which normalizes the reflected light amount characteristic judged by the judgment section using a component proportional to the emission power to provide a normalized reflected light amount characteristic; and a write power determination section which determines the optimum write power on the basis of the normalized reflected light amount characteristic by the normalization section.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram of an optical disk recording/reproducing apparatus to which the principles of the present invention is applied;

FIG. 2 shows received light amount versus laser emission power;

FIG. 3 is a schematic block diagram illustrating the arrangement associated with write power control in the laser control circuit in FIG. 1;

FIG. 4 is a flowchart illustrating a control operation according to an embodiment of the present invention;

FIG. 5 is a diagram for use in explanation of measurement of the amount of reflected light;

FIGS. 6A and 6B show normalized reflection characteristics; and

FIG. 7 is a flowchart for write power control at information record time.

### DETAILED DESCRIPTION OF THE INVENTION

An embodiment of the present invention will be described in detail with reference to the accompanying drawings. The description which follows does not restrict the apparatus and method of the present invention.

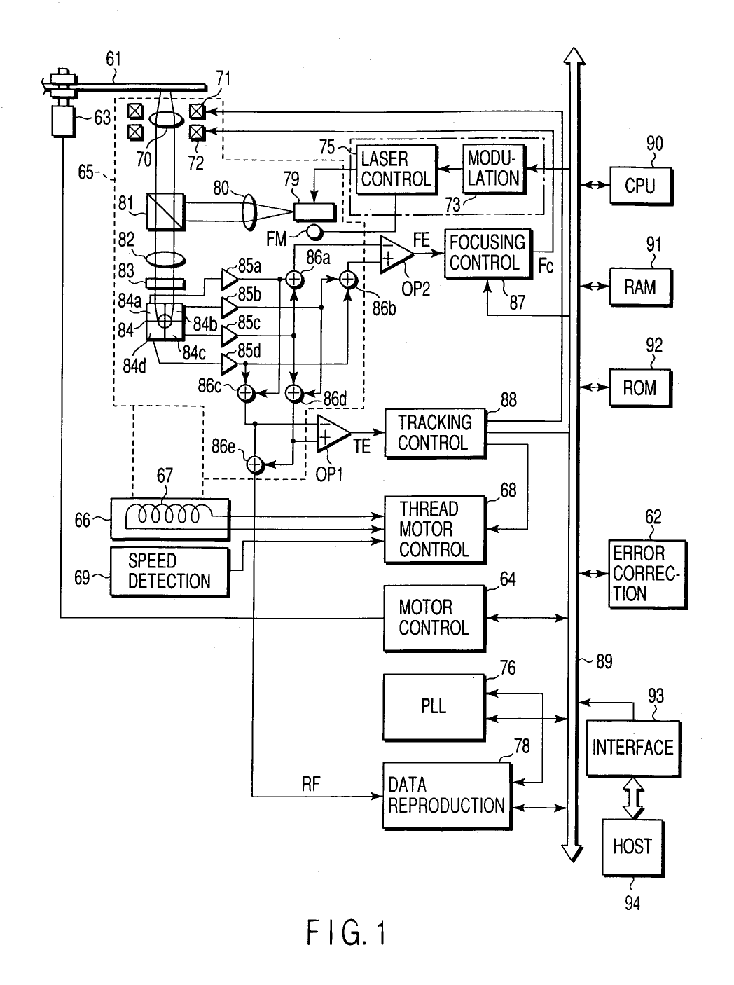

FIG. 1 is a block diagram of an optical disk recording/reproducing apparatus to which the principles of the present invention is applied. As an optical disk 1 use may be made of a user data recordable disk or a read-only disk. The embodiment will be described with the optical disk 1 as a recordable optical disk. Recordable optical disks include DVD-R, DVD-RAM, CD-R, and CD-RW.

The optical disk 61 is formed on top with a land track and a groove track in the form of a spiral and is rotated by a spindle motor 63.

Recording onto and playback from the optical disk 61 are performed by means of an optical pickup 65. The optical pickup 65 is coupled through gears with a thread motor 6, which is controlled by a thread motor control circuit 68.

To the thread motor control circuit 68 is connected a speed detection circuit 69 which detects the speed of the optical pickup 65 and then sends the detected speed signal to the thread motor control circuit 68. The thread motor 66 is provided on its stationary portion with a permanent magnet, not shown, and has its drive coil 67 excited by the thread motor control circuit 68 to move the optical pickup 65 in the radial direction of the disk.

The optical pickup 65 is provided with an objective lens 65 supported by a wire or leaf spring, not shown. The objective lens 65 is adapted to move in the focusing direction (the direction of the optical axis of the lens) when driven by a drive coil 72 or in the tracking direction (the direction perpendicular to the direction of the optical axis of the lens) when driven by a drive coil 71.

A modulation circuit 73 performs eight to fourteen modulation (EFM) on user data supplied from a host device 94 through an interface circuit 93 at information record time to provide EFM data. A laser control circuit 75 provides a writing signal based on the EFM data supplied from the modulation time 73 to a semiconductor laser diode 79 at information record time (at mark formation time). Also, the laser control circuit 75 applies a reading signal, smaller in magnitude than the write signal, to the semiconductor laser diode 79 at information read time.

The semiconductor laser diode 79 emits laser light in response to a signal from the laser control circuit 75. The laser light emitted from the semiconductor laser diode 79 is directed through a collimator lens 80, a half prism 81, the objective lens 70 onto the optical disk 61. Reflected light from the optical disk 61 is directed through the objective lens 70, the half prism 81, a condenser lens 82, and a cylindrical lens 83 to a photosensor 84.

The photosensor 84 is a four-quadrant photosensor comprising photocells 84a to 84d. The output signals of these cells are applied through current-to-voltage conversion amplifiers 85a to 85d and adders 86a to 86d to differential amplifiers OP1 and OP2.

The differential amplifier OP2 produces a focus error signal FE corresponding to the differential between the output signals of the adders 86a and 86b. The focus error signal is applied to a focusing control circuit 87 the output signal of which is applied to the focusing drive coil 72. This ensures that the laser light is always kept focused on the recording layer of the optical disk 61.

The differential amplifier OP1 produces a tracking error signal TE corresponding to the differential between the output signals of the adders 86c and 86d. The tracking error signal is applied to a tracking control circuit 88, which produces a tracking control signal.

The tracking control signal output from the tracking control circuit 88 is applied to the drive coil 71 for tracking control. The tracking error signal used in the tracking control circuit 88 is also applied to the thread motor control circuit 68.

By performing the focusing control and tracking control, variations in the intensity of reflected light from the track of the optical disk 61 corresponding to the recorded information will appear in the sum of the output signals of the four photocells 84a to 84d of the photosensor 84, i.e., the output signal RF of an adder 86e which adds the output signals of the adders 86c and 86d. The output signal RF is thus applied to a data reproduction circuit 78.

The data reproduction circuit 78 reproduces recorded data in response to a clock signal from a PLL circuit 76. The data reproduction circuit 78 also has a function of measuring the amplitude of the input signal RF. The measured value is read by a CPU 90.

When the objective lens 70 is controlled by the tracking control circuit 68, the tread motor 66, i.e., the optical pickup 65, is controlled by the thread motor control circuit 68 so that the objective lens is located in the vicinity of the center of the optical pickup.

The motor control circuit 64, the thread motor control circuit 68, the modulation circuit 73, the laser control circuit 75, the PLL circuit 76, the data reproduction circuit 78, the focusing control circuit 87, and the tracking control circuit 88 can be built into a single LSI chip. These circuits are controlled by means of the CPU 90 through a bus 89. The CPU is responsive to operating commands supplied from the host device 94 through the interface circuit 93 to control the optical disk recording/reproducing apparatus. The CPU uses a RAM 91 as a working area and performs predetermined operations in accordance with programs, including present inventory control operations stored in a ROM 92.

Next, the optimization of the laser write power according to the present invention will be described.

With recordable optical disks, such as DVD-RAM, DVD-R, CD-RW, and CD-R, at write power adjustment time, the amplitude of the sum RF of all four outputs from the pickup 65 is measured as the amount of reflected light from the disk while the emission power of the semiconductor laser diode 79 is changed. The write power is determined so that the amount of reflected light is of a certain value.

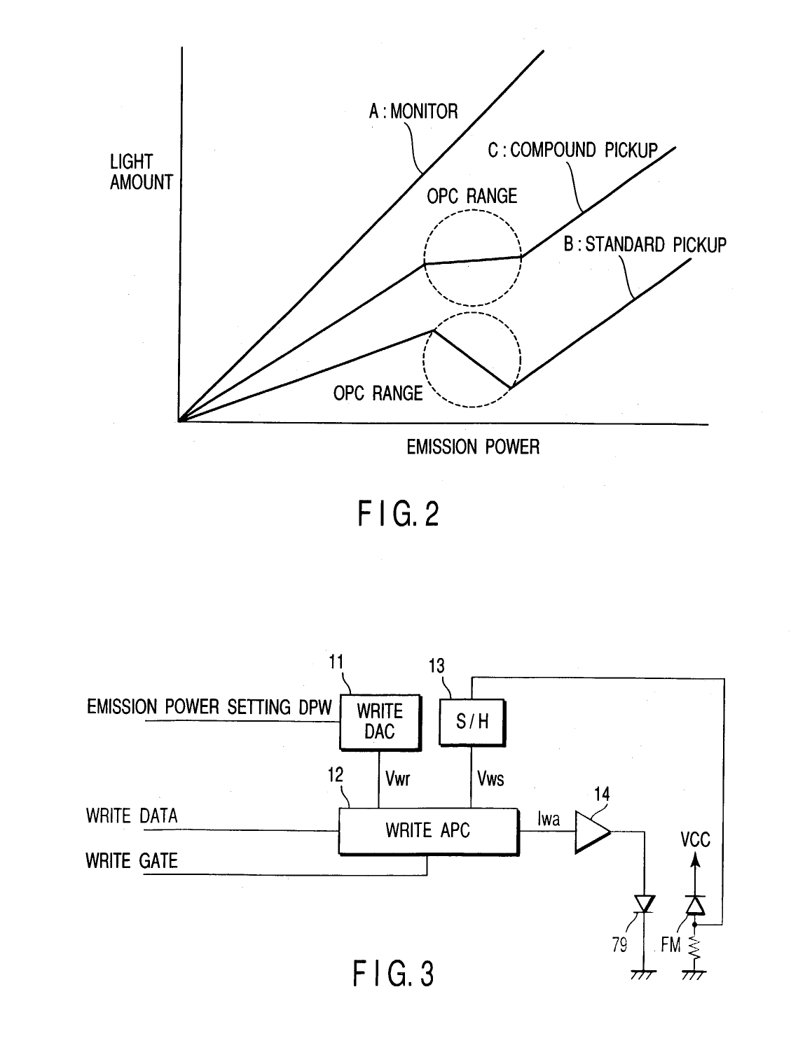

FIG. 2 shows light amount against emission power. The emission power is set in the laser control circuit 75 by the CPU 90. The characteristic A indicates the amplitude of the output of a front monitor FM for laser emission power levels as the received light amount. The characteristic B indicates the amplitude of the sum RF of all four outputs from a standard optical pickup, adapted for CD only, for emission power levels as the amount of reflected light. The characteristic C indicates the amplitude of the sum RF of all four outputs from a compound optical pickup, adapted for both DVD and CD, for emission power levels as the amount of reflected light.

With the characteristics B and C, in the low emission power range in which the emission power is too low to record marks on an optical disk, the amount of reflected light increases with increasing emission power. With the characteristic B, however, in the range (OPC range) in which the emission power is increased enough to allow marks to be recorded on the disk and the write power is optimized, part of the emission power is absorbed by the disk, and consequently the amount of reflected light decreases with increasing emission power. The write power is adjusted in this OPC range.

In the case of the characteristic C, the amount of reflected light little changes or increases when the emission power is increased in the OPC range. That is, the reflected light amount characteristic varies between optical pickups. Thus, it becomes difficult to grasp clearly the amount by which the reflected light amount is reduced due to absorption by the disk when the emission power is increased in the OPC range, therefore the optimum write power is impossible to determine.

As shown in FIG. 2, the output A of the monitor increases with increasing emission power. In this embodiment, the amount of reflected light is normalized using a component, such as the monitor output A, that is proportional to laser emission power, to extract a decrease in the amount of reflected light due to absorption by the disk.

FIG. 3 is a schematic block diagram illustrating the arrangement associated with write power control in the laser control circuit 75 in FIG. 1. The arrangement for read power control at data reproduction time is omitted for the purpose of simplifying illustration.

A write DAC 11 provides digital-to-analog conversion (DAC) of an emission power setting DPW to a reference voltage Vwr. The reference voltage Vwr is output to a write APC (automatic power controller) 12, which makes a comparison between an output voltage Vws of a sample and hold circuit 13 and the write reference voltage Vwr and then produces an output current Iwa corresponding to the result of the comparison when a write gate signal is at a high level and write data is at a high level. The current Iwa is amplified by an amplifier 14 to drive the laser diode 79. The laser diode 79 emits laser light of a power corresponding to the supplied current.

A front monitor FM, comprised of a photodiode, detects the intensity of the laser light emitted from the laser diode 79 and then sends a signal to the sample and hold circuit 13. The sample and hold circuit samples the signal from the front monitor FM at a time when the write data is at the high level and provides the sampled voltage to the write APC 12. As a result, the write APC 12 outputs a current Iwa that causes the laser diode 79 to emit light at the power level corresponding to the emission power setting DPW.

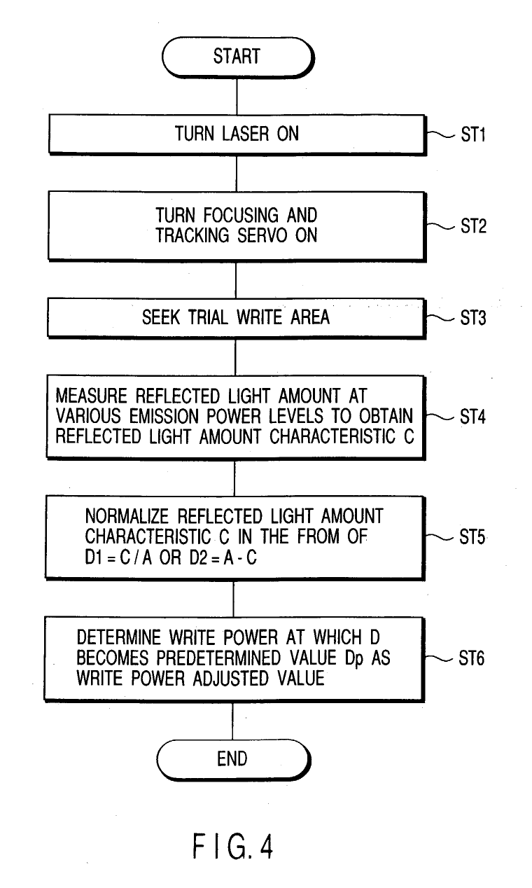

The control operation of the present invention will be described below in detail. FIG. 4 is a flowchart of the control operation according to an embodiment of the present invention.

When a recordable optical disk 61 is loaded into the recording/reproducing apparatus, the CPU 90 causes the laser diode 79 to emit light at a read power level at data reproduction time (ST1) and then causes the focusing control circuit 87 and the tracking control circuit 88 to perform focusing control and tracking control, respectively (ST2). As a result, the laser beam follows the track on the spinning optical disk 61 under an in-focus condition.

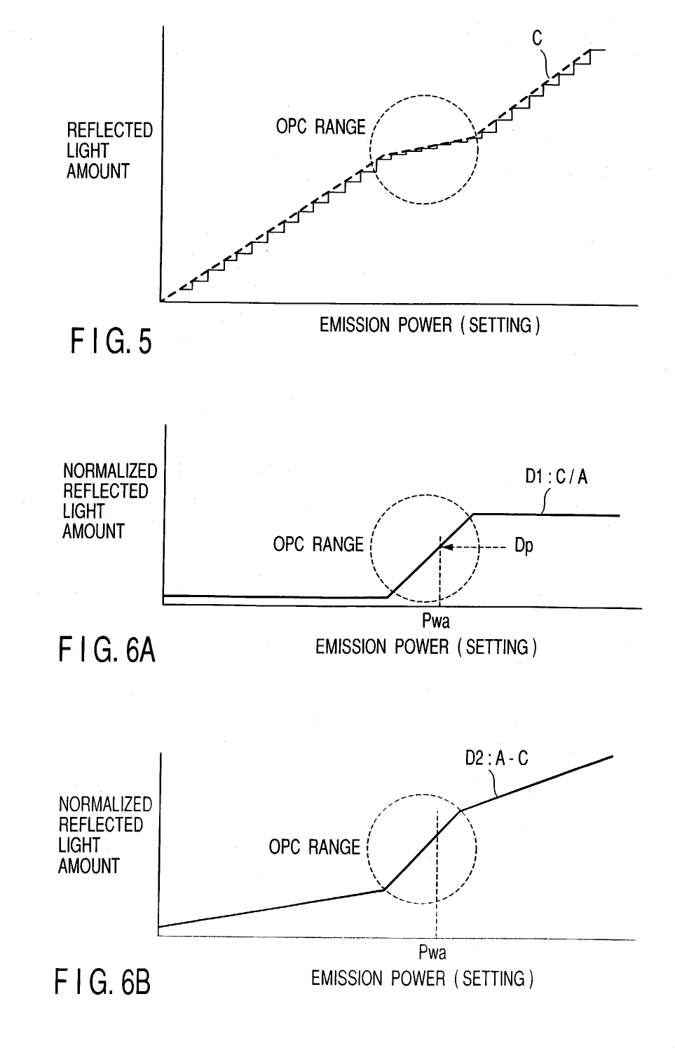

Next, the CPU 90 moves the pickup 65 to seek a track portion having a trial write area (ST3). Upon completion of movement to the target track portion, the CPU 90 reads the amount of reflected light (the amplitude value of the signal RF) from the data reproduction circuit 78 while increasing the emission power level step by step (the emission power setting DPW) as indicated by a stepped solid line in FIG. 5. The reading of the amount of reflected light is performed each time the emission power level is changed. The CPU 90 writes the amount of reflected light into the RAM 91 for each emission power level (ST4). Further, in step ST4, a reflection characteristic C, as indicated by a broken line in FIG. 5, is determined from the emission power and the amount of reflected light, which have been recorded in the RAM 91.

In step ST5, the normalized reflected light amount D1 or D2 is determined as follows:

D1=C/A (1)

or

D2=A−C (2)

Here, A may be a component proportional to the emission power as indicated by A in FIG. 2 or the emission power setting DPW.

FIGS. 6A and 6B show normalized reflection characteristics D1 and D2, respectively. Thus, in the present invention, the power control is performed using the normalized reflection characteristic C/A or C−A by such a reflected light amount characteristic A as shown in FIG. 2 (the front monitor output or the emission power setting) as opposed to using such a characteristic as indicated by B or C in FIG. 2 as it is. It is noted that FIG. 6A shows a case when the characteristic A is smaller than the characteristic C.

In comparison with the OPC range shown in FIG. 5, in the OPC range shown in FIGS. 6A and 6B, the gradient of the characteristic is greater, allowing the OPC range to be identified readily. Thus, the change of the reduced amount of reflected light (the amount of power absorbed by the disk) with respect to change of emission power can be judged.

In the conventional system in which the amount of reflected light is used as it is for power control, there is no problem with the pickup having the characteristic B of FIG. 2; however, with the pickup of the characteristic C, the power control may not come to a successful end. That is, to determine the optimum write power, different control approaches have to be used for the pickup of the characteristic B, in which the amount of reflected light decreases with increasing emission power in the OPC range, and the pickup of the characteristic C, in which the amount of reflected light increases. For example, suppose that, in the OPC range, the amount of reflected light is lower than a predetermined value (the amount of reflected light corresponding to the optimum write power). Then, the pickup of the characteristic C needs to increase the emission power, while the pickup of the characteristic B needs to decrease the emission power.

In the system of the present invention, however, the direction of the change of the normalized reflected light amount with respect to emission power is the same for the pickups of the characteristics B and C as indicated by D1 or D2 in FIGS. 6A and 6B; thus, the above problem can be circumvented.

Finally, the CPU 90 determines, as the write power adjusted value, a write power Pwa at which the normalized reflected light amount attains predetermined value Dp for each type of optical disk, such as CD-RW, DVD-RW, etc. (ST6). The value Dp varies according to type of optical disk.

The write power control at record time will be described next.

The normalized reflected light amount characteristic as shown in FIG. 6 varies according to disk tilt (warp), temperature, and humidity. The tilt of the disk also varies according to the position of the optical pickup in the radial direction of the disk. To record information at the optimum write power at all times, therefore, the write power must always be adjusted during the recording.

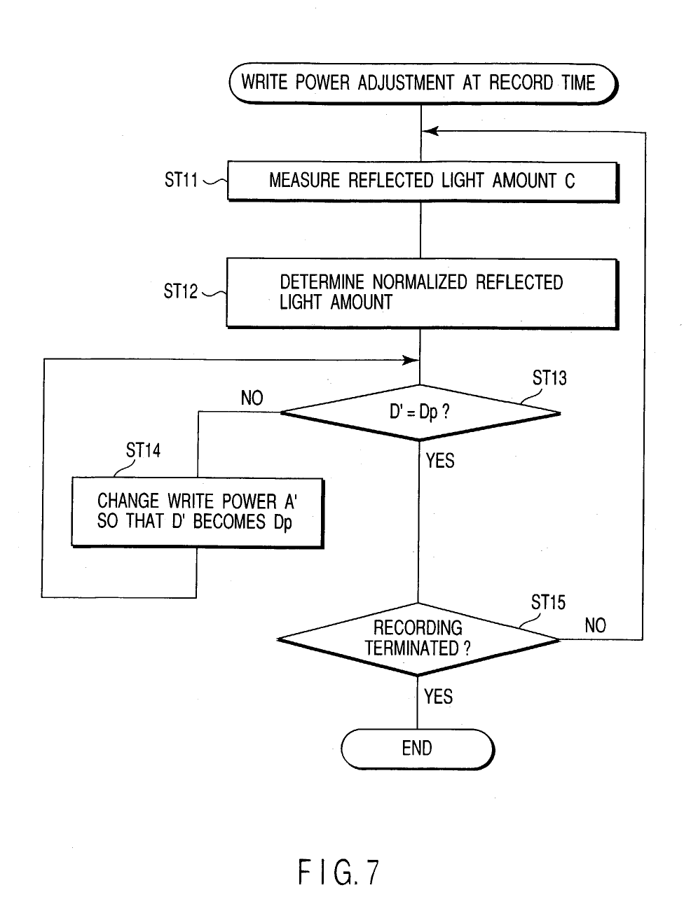

FIG. 7 is a flowchart for write power control at record time.

Upon receiving a write command from the host device 94, the CPU 90 moves the pickup 65 to a target track and starts the recording of information. During the information recording, the CPU 90 measures the reflected light amount C′ (step ST11). The reflected light amount C′ corresponds to the maximum amplitude of the sum signal RF of all four outputs of the photosensor applied to the data reproduction circuit 78.

Next, the CPU 90 determines the normalized reflected light amount D′ by dividing the reflected light amount C′ by the current setting A′ in the write APC 12 (ST12). A decision is then made as to whether or not the resulting reflected light amount D′ is in agreement with the predetermined value Dp referred to in step ST6 in FIG. 4 (step ST13). If NO in step ST13, the CPU 90 changes the write power setting A′ so that the normalized reflected light amount D′ reaches the predetermined value Dp (ST14). The CPU 90 carries out steps ST11 through ST15 repeatedly throughout information recording. Thus, the laser write power is always adjusted to the optimum value at the information record time.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk recording and reproducing apparatus comprising:
a laser light emitting section which directs laser light onto an optical disk;
a control section which measures the amount of reflected light from the optical disk while changing the emission power of the laser emitting section and controls a reflected light amount characteristic of reflected light amount versus emission power;
a normalization section which normalizes the reflected light amount characteristic controlled by the control section using a component proportional to the emission power to provide a normalized reflected light amount characteristic; and
a write power determination section which determines the optimum write power on the basis of the normalized reflected light amount characteristic.

2. The optical disk recording and reproducing apparatus according to claim 1, wherein the laser light emitting section includes a laser control circuit which causes a laser to emit laser light at an emission power level corresponding to an input setting value, and the component proportional to the emission power is the input setting value.

3. The optical disk recording and reproducing apparatus according to claim 1, further comprising a photodetector section FM which receives the laser light to detect its intensity, wherein the component proportional to the emission power is the intensity of the laser light detected by the photodetector section.

4. The optical disk recording and reproducing apparatus according to claim 1, wherein the normalization section provides the ratio of the amount of reflected light to the component proportional to the emission power as the normalized reflected light amount characteristic.

5. The optical disk recording and reproducing apparatus according to claim 1, wherein the normalization section provides the difference between the amount of reflected light to the component proportional and the emission power as the normalized reflected light amount characteristic.

6. The optical disk recording and reproducing apparatus according to claim 1, further comprising a second normalization section which, at the time of recording information on the optical disk, measures the amount of reflected light and normalizes it using a component proportional to emission power, and a write power adjusting section which adjusts the write power so that the normalized reflected light amount by the second normalization section reaches a predetermined value.

7. For use with an optical disk recording and reproducing apparatus which directs laser light onto an optical disk to record or reproduce information on or from it, a method of adjusting write power at information record time comprising:
measuring the amount of reflected light from the optical disk while changing laser light emission power, to obtain a reflected light amount characteristic of reflected light amount versus emission power;
normalizing the reflected light amount characteristic using a component proportional to the emission power to obtain a normalized reflected light amount characteristic; and
determining the optimum write power on the basis of the normalized reflected light amount characteristic.

8. The write power adjustment method according to claim 7, wherein the optical disk recording and reproducing apparatus includes a laser control circuit which causes a laser to emit laser light at an emission power level corresponding to an input setting value, and the component proportional to the emission power is the input setting.

9. The write power adjustment method according to claim 7, wherein the normalization step obtains the ratio of the amount of reflected light to the component proportional to the emission power as the normalized reflected light amount characteristic.

10. The write power adjustment method according to claim 7, further comprising, at the time of recording information on the optical disk, measuring the amount of reflected light, normalizing it using a component proportional to emission power, and adjusting the write power so that the normalized reflected light amount reaches a predetermined value.
